(19) United States
(12) Patent Application Publication
(10) Pub. No.: US 2015/0174881 A1
(43) Pub. Date: Jun. 25, 2015

(54) RF NODE WELDING OF CORRUGATED HONEYCOMB CORE

(71) Applicant: C&D ZODIAC, INC., Huntington Beach, CA (US)

(72) Inventors: Michael O. Stoll, Huntington Beach, CA (US); Thomas J. Grobelny, Marysville, WA (US); Matthew S. Taylor, Marysville, WA (US)

(21) Appl. No.: 14/577,398

(22) Filed: Dec. 19, 2014

Related U.S. Application Data
(63) Continuation of application No. 61/919,564, filed on Dec. 20, 2013.

(51) Int. Cl. B32B 37/12; B32B 37/14; B32B 38/00; B32B 3/12

(52) U.S. Cl. CPC B32B 37/1292; B32B 3/12; B32B 37/146; B32B 38/0012; B32B 2037/1246

(57) ABSTRACT

A method of bonding a first corrugated sheet and a second corrugated sheet to provide a honeycomb core assembly. The first corrugated sheet includes a plurality of lower node regions and the second corrugated sheet includes a plurality of upper node regions. The method includes applying a radio frequency activatable adhesive to one or both of a first lower node region of the first corrugated sheet and a first upper node region of the second corrugated sheet, positioning the first corrugated sheet adjacent to or in contact with the second corrugated sheet at the first upper node region and the first lower node region, and exposing the radio frequency activatable adhesives to a radio frequency to activate the radio frequency activatable adhesive, such that the first corrugated sheet is bonded to the second corrugated sheet.

### CROSS REFERENCE TO RELATED APPLICATIONS

This application claims the benefit of U.S. Provisional Application No. 61/919,564 filed Dec. 20, 2013, which is incorporated herein by reference in its entirety.

### FIELD OF THE INVENTION

The present invention relates generally to methods of welding of honeycomb core, and more particularly to methods of utilizing RF activatable adhesives for welding of honeycomb core.

### BACKGROUND OF THE INVENTION

Honeycomb core is used in many industries, e.g., the aerospace industry. Traditional honeycomb manufacturing is generally accomplished by one of three types of processes: 1) expansion, wherein the honeycomb is bonded or welded at nodes in flat stacks, cured, and then expanded to the desired cell size; 2) corrugation, wherein the honeycomb substrate is corrugated into rigid sheets, applied with adhesives at the node regions, stacked in a honeycomb geometry, and then bonded into a honeycomb core; and 3) unitary thermoplastic core manufacturing, wherein a honeycomb core is formed one half cell at a time using heated cell formers. For example, see U.S. Pat. No. 6,451,406, issued on Sep. 17, 2002 to Wang, the entirety of which is incorporated herein by reference.

### SUMMARY OF THE PREFERRED EMBODIMENTS

The present invention involves the production of honeycomb core using radio frequency (“RF”) activated thermoplastic adhesives. RF activated thermoplastic adhesives and RF activation based welding can enable faster processing times, eliminate or reduce the need for adhesives (however, non-RF activated adhesives can still be used, if desired), and allow for localized heating at the bondline.

In accordance with a first aspect of the present invention there is provided a method of bonding a first corrugated sheet and a second corrugated sheet to provide a honeycomb core assembly. The first corrugated sheet includes a plurality of lower node regions and the second corrugated sheet includes a plurality of upper node regions. The method includes applying a radio frequency activatable adhesive to one or both of a first lower node region of the first corrugated sheet and a first upper node region of the second corrugated sheet, positioning the first corrugated sheet adjacent to or in contact with the second corrugated sheet at the first upper node region and the first lower node region, and exposing the radio frequency activatable adhesives to a radio frequency to activate the radio frequency activatable adhesive, such that the first corrugated sheet is bonded to the second corrugated sheet. In a preferred embodiment, the method includes applying a radio frequency activatable adhesive to one or both of a second lower node region of the first corrugated sheet and a second upper node region of the second corrugated sheet prior to placing the sheets adjacent to one another.

In accordance with another aspect of the present invention there is provided a method of providing a honeycomb core member that includes obtaining a sheet of substrate, and corrugating the sheet of substrate to form a corrugated substrate that includes a plurality of ridges and troughs. Each ridge includes an upper node region on an upper surface thereof, and each trough includes a lower node region on a lower surface thereof. The method also includes applying radio frequency activatable adhesive to at least some of the upper and lower node regions of the corrugated substrate, cutting the corrugated substrate into at least first and second corrugated sheets, positioning the first corrugated sheet adjacent to or in contact with the second corrugated sheet such that at least some of the lower node regions of the first corrugated sheet are in contact with at least some of the upper node regions of the second corrugated sheet to form a honeycomb stack, exposing the radio frequency activatable adhesive to a radio frequency, such that the first corrugated sheet is bonded to the second corrugated sheet to form a honeycomb core assembly, and cutting the honeycomb core member from the honeycomb core assembly. The steps of the method can be reversed if desired. For example, the adhesive can be applied to the substrate prior to corrugation or after the corrugated sheets have been cut.

In a preferred embodiment, the method includes stacking the first corrugated sheet on the second corrugated sheet such that the troughs of the first corrugated sheet are received in the troughs of the second corrugated sheet to form a nested stack. This step is preferably done prior to forming the honeycomb stack. The method also can include transporting the nested stack from a first location to a second location. The second location is preferably remote from the first location, and may be, for example, a distribution site or a point of use.

In accordance with another aspect of the present invention there is provided a honeycomb core member produced by a process that includes the steps of providing a honeycomb core member that includes obtaining a sheet of substrate, and corrugating the sheet of substrate to form a corrugated substrate that includes a plurality of ridges and troughs. Each ridge includes an upper node region on an upper surface thereof, and each trough includes a lower node region on a lower surface thereof. The method also includes applying radio frequency activatable adhesive to at least some of the upper and lower node regions of the corrugated substrate, cutting the corrugated substrate into at least first and second corrugated sheets, positioning the first corrugated sheet adjacent to or in contact with the second corrugated sheet such that at least some of the lower node regions of the first corrugated sheet are in contact with at least some of the upper node regions of the second corrugated sheet to form a honeycomb stack, exposing the radio frequency activatable adhesive to a radio frequency, such that the first corrugated sheet is bonded to the second corrugated sheet to form a honeycomb core assembly, and cutting the honeycomb core member from the honeycomb core assembly.

In accordance with another aspect of the present invention there is provided a method for bonding a first corrugated sheet of substrate and a second corrugated sheet of substrate. The method includes applying a radio frequency activatable adhesive to the first corrugated sheet at node regions; contacting the first corrugated sheet with the second corrugated sheet at the node regions; and exposing the radio frequency adhesives to a corresponding radio frequency to active the adhesive so that upon adhesive activation, the first corrugated honeycomb sheet bonds the second corrugated honeycomb sheet at the node regions.

In accordance with still another aspect of the present invention there is provided a modified corrugated sheet of substrate comprising a corrugated sheet of substrate with materials of RF activatable adhesives applied at adhesive regions.

The present invention utilizes technology to bond corrugated honeycomb nodes by RF activation. In particular, the present invention can be used for honeycomb panels for commercial passenger aircraft. However, this is not a limitation on the present invention. The technology allows node bonding of medium and high gauge paper or film with little added weight in the form of node bond adhesive. As discussed more fully below, through the compactness of stacked corrugated sheets, the RF activation process taught herein also enables less expensive transportation of honeycomb core (compared to the prior art) by shifting expansion of the honeycomb core to distribution sites or at point of use. For example, a distribution site may be a first facility that is somewhere other than the factory where manufactured goods would be shipped and staged for delivery to a customer. A point of use site can be another manufacturing or assembly area where the manufactured goods are assembled or fabricated in to a next level assembly.

The present invention utilizes a blend of RF activators and thermoplastic additives (above 0% to 99%) to form a thermoplastic adhesive that absorbs radio frequency energy at specific frequencies for the purpose of welding to the parent thermoplastic material, with little to no heat deformation of the parent material and cell structure. In a preferred embodiment, the adhesive is applied at the corrugation nodes immediately after corrugation. Corrugated sheets may be nested for transportation and storage. Then after transportation and/or storage, when the honeycomb core is ready to be produced, at the point of use or the distribution site, corrugated sheets are stacked into honeycomb geometry, applied with RF radiation at a specific frequency to form bonded honeycomb sheets.

It will be appreciated by those of ordinary skill in the art that the present invention provides: (1) a corrugation process to be applied to honeycomb thermoplastic core; (2) time insensitivity between corrugation and stacking/bonding processes; (3) transportation of honeycomb core in dense/compact nested stacks; (4) higher node bond strengths at forming temperatures (compared to the prior art); and (5) lighter weight node bond adhesives (compared to the prior art).

Described herein are preferred embodiments of methods for RF activated honeycomb node welding utilizing RF activatable adhesives. The method includes applying RF activatable adhesives to node or adhesives regions of a first corrugated sheet of substrate, contacting the first corrugated sheet with a second corrugated sheet of substrate at the node or adhesive regions; and exposing the corrugated sheets to a radio frequency to activate the RF adhesive and therefore weld or bond the two corrugated sheets at node regions to form a row of cells of honeycomb. It will be appreciated by those of ordinary skill in the art that the method can be repeated multiple times as necessary to form a honeycomb core of any desired size.

The process described herein can be applied to thermoset resin based core that was cured in the corrugated form and bonded with a RF activatable adhesive. Other substrates can be, but are not limited to fiberglass, boron, ceramic or other fibers, fibers combined with epoxy, cynate ester, phenolic, or other thermosetting resin, shaped and cured into the corrugated form and bonded together using an RF adhesive. Any substrate that can be formed into thin corrugated sheets and allows the passage of RF energy can be bonded into honeycomb using the methods described herein.

Fibers could also be incorporated into the thermoplastic resins and process by this method as well. The fibers could be in fabric, mat, chopped or milled form.

The invention, together with additional features and advantages thereof, may be best understood by reference to the following description.

### BRIEF DESCRIPTION OF THE DRAWINGS

FIG. 1 is a perspective view of a honeycomb core assembly in accordance with another preferred embodiment of the present invention;

FIG. 2 is an exploded view of first and second corrugated sheets that include RF activatable adhesive on each of the upper and lower nodes thereof;

FIG. 3 is a perspective view of a honeycomb core assembly;

FIG. 4A shows a substrate being corrugated;

FIG. 4B shows first and second corrugated sheets;

FIG. 4C shows a nested stack of corrugated sheets;

FIG. 4D shows a honeycomb stack prior to adhesive activation;

FIG. 4E shows radio frequency being applied to the honeycomb stack to bond the corrugated sheets together and to form a honeycomb core assembly; and

FIG. 4F shows a honeycomb core member cut from the honeycomb core assembly.

a simplified schematic representation of an exemplary formation process of a honeycomb core in accordance with a preferred embodiment of the present invention,

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an other embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. Appearances of the phrase “in one embodiment” in various places in the specification do not necessarily refer to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “upper,” “lower” “short,” “long,” “up,” “down,” and “below” used herein are merely for ease of description and refer to the orientation of the components as shown in the figures. It should be understood that any orientation of the components described herein is within the scope of the present invention.

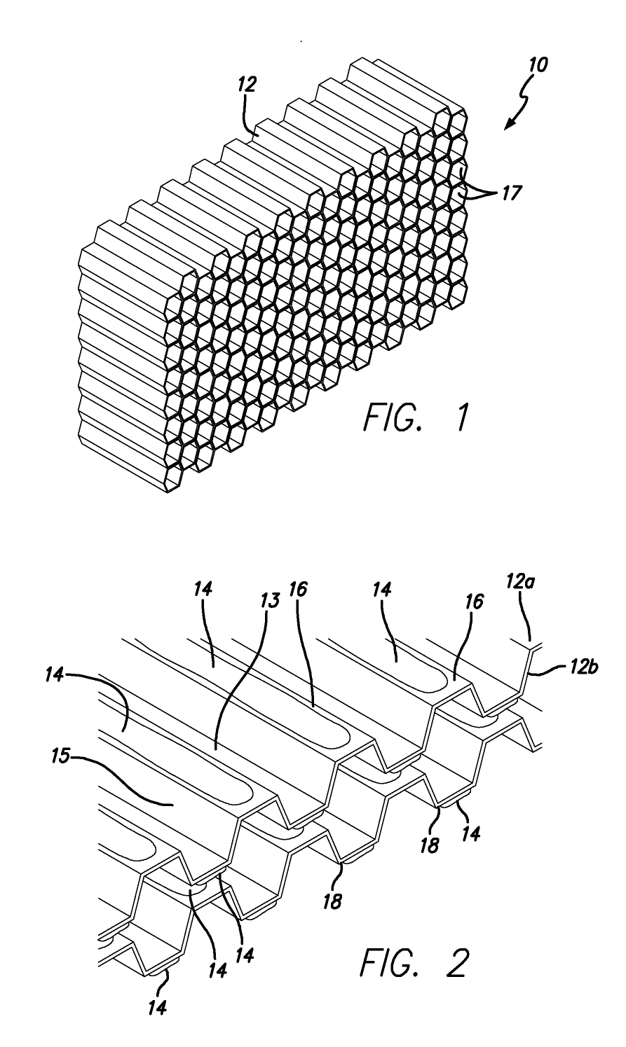

Referring now to the drawings, wherein the showings are for purposes of illustrating the present invention and not for purposes of limiting the same, FIGS. 1-3 show a preferred embodiment of a honeycomb core assembly 10 bonded using RF activation and a process for making same. The process generally involves constructing a honeycomb core assembly from corrugated sheets 12 of substrate using RF activatable adhesives 14. The process is illustrated utilizing two corrugated sheets 12 of substrate. It will be appreciated that the substrate can be any thermoplastic material or substrate that is typically used for manufacturing honeycomb core. For example, the substrates can be made of medium and high gauge paper, film or the like. As shown in FIG. 2, each corrugated sheet 12 includes a series of troughs 13 and ridges 15 and includes an upper surface 12a and a lower surface 12b. The upper surface 12a includes multiple upper node regions 16 (at each ridge 15), and the lower surface 12b includes multiple lower node regions 18 (at each trough 13). It will appreciated by those of ordinary skill in the art that the node regions are the areas of the corrugated sheets that are bonded together to form the honeycomb core assembly.

RF activatable adhesive 14 is applied to the upper and lower node regions 16 and 18 of each corrugated sheets 12 where it will be bonded to another corrugated sheet 12. It should be appreciated by those of ordinary skill in the art that that RF activatable adhesives can either form a continuous layer at the node regions 16, 18 or be applied in a non-continuous manner. Furthermore, the adhesive 14 can be applied to both the upper and lower node regions 16 and 18 or to one or the other of the upper and lower node regions 16 and 18. The upper corrugated sheet 12 is then placed on the lower corrugated sheet 12 such that the lower node regions 18 of the upper corrugated sheet 12 rest on the upper node regions 16 of the lower corrugated sheet 12. Radio frequency at a predetermined frequency is then applied to the node regions to activate the adhesive 14 thereon. Upon exposure to the corresponding radio frequency, the RF activatable adhesives bond the lower node regions 18 of the upper corrugated sheet 12 to the upper node regions 16 of the lower corrugated sheet 12 to form the honeycomb core assembly 10, as shown in FIG. 3. In the honeycomb core assembly 10, adjacent troughs 13 and ridges 15 cooperate to form a cell 17. The bonding process can be repeated multiple times as needed to bond additional corrugated sheets 12 to construct a honeycomb core assembly 10 of a desired size. In each bonding step, the upper node regions 16 of a lower corrugated sheet 12 will bond the lower node regions 18 of an upper corrugated sheet 12 upon activation of RF activatable adhesives 14 applied thereto.

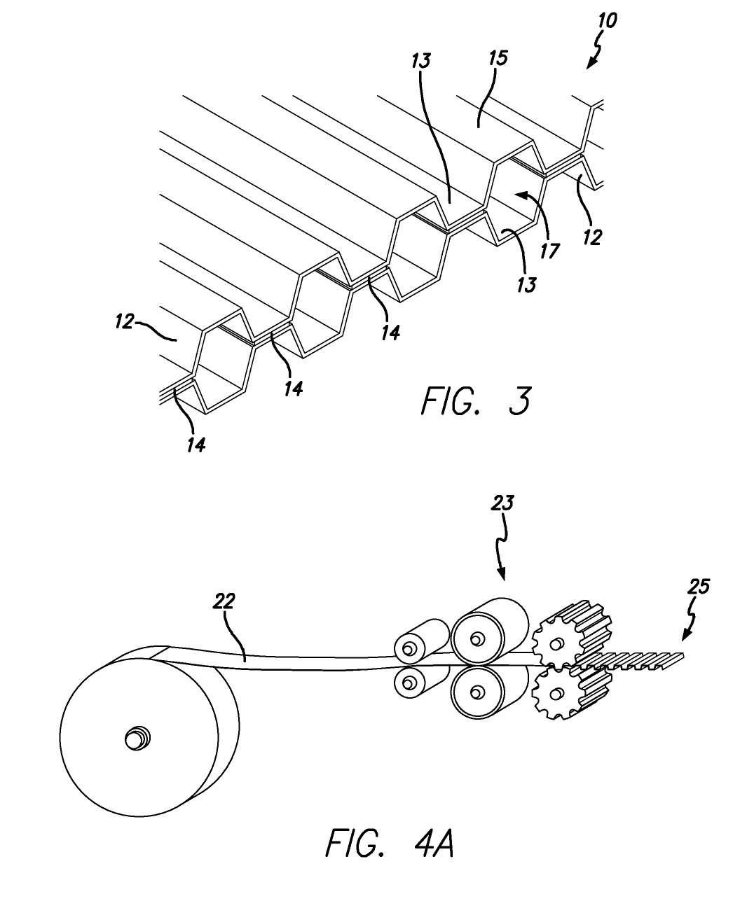

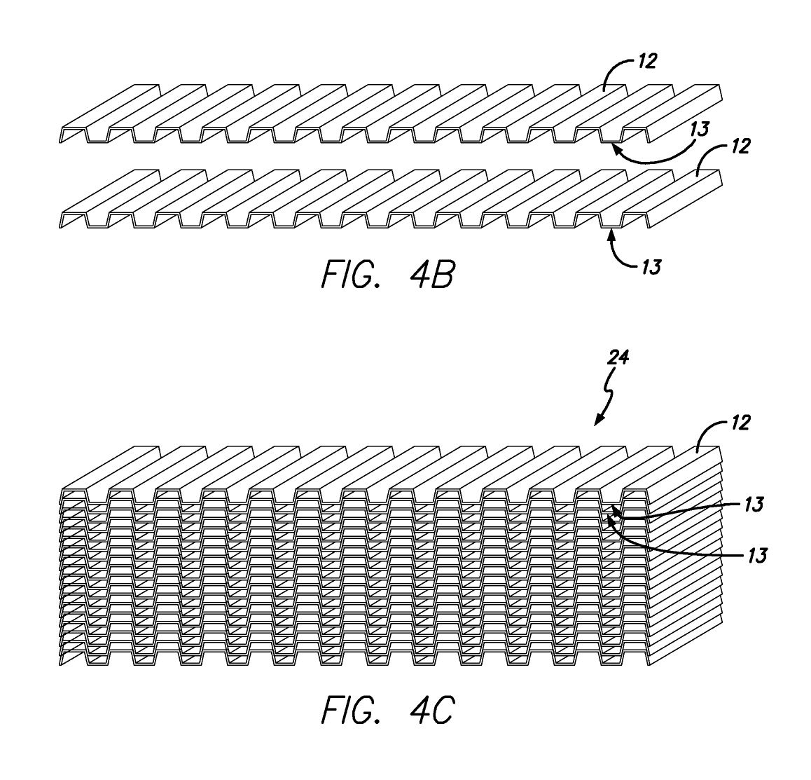

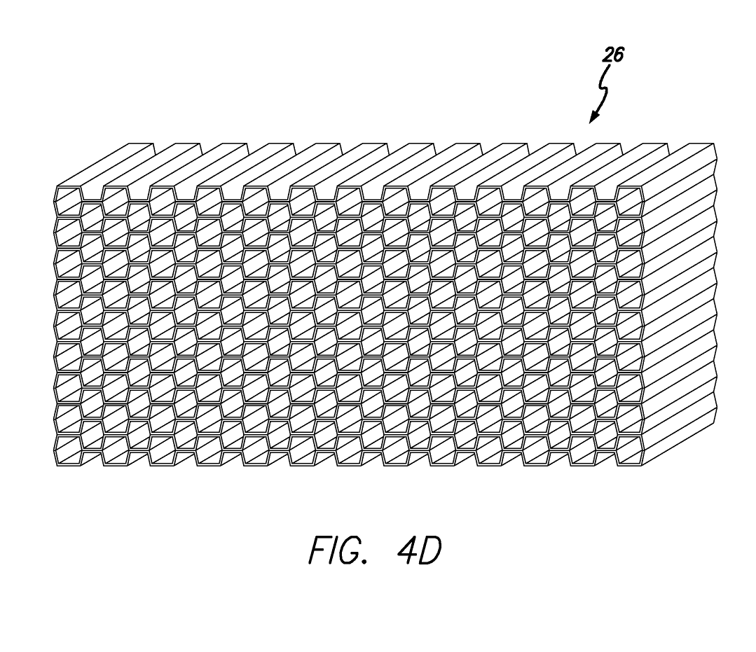

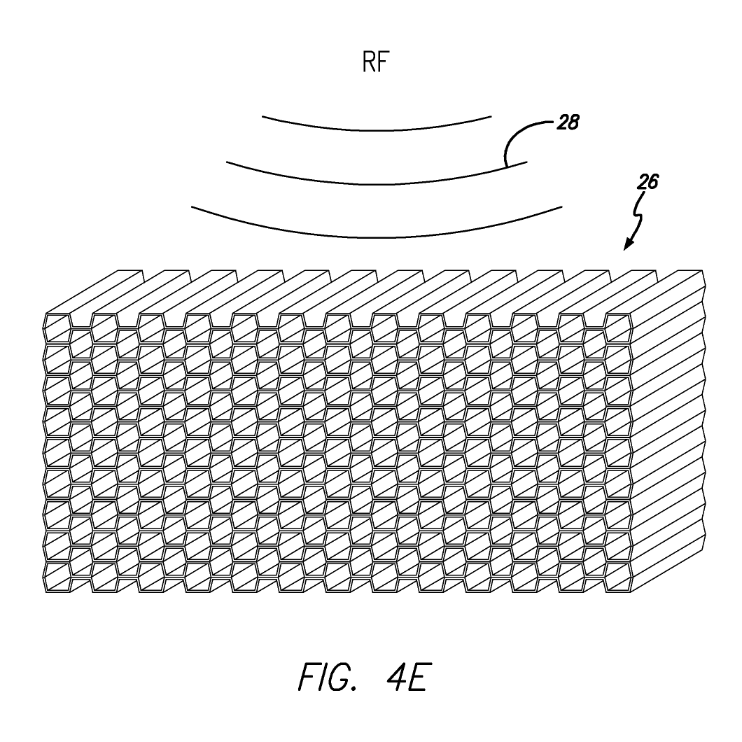

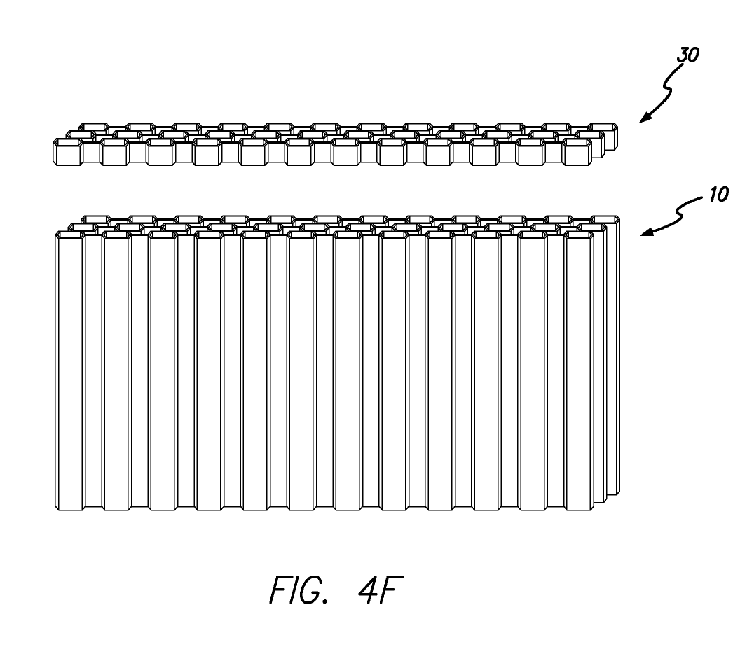

FIGS. 4A-4F shows a number of steps in the process for manufacturing a honeycomb core assembly 10. The steps should not be taken as exhaustive, but only as exemplary. As shown in FIG. 4A, the process begins with a flat substrate 22 that is run through a series of rollers 23 or the like that heat the substrate, corrugate the substrate (to provide a corrugated substrate 25) and apply the RF activatable adhesive 14 to the upper and lower node regions 16, 18. In a preferred embodiment, heat and pressure is used to corrugate the flat substrate 22 (for example, if it is a thermoplastic substrate), as indicated by the rollers 23 in FIG. 4A. However, for other materials, heat may not be necessary. The RF activated adhesive 14 is preferably only applied at the nodes. The adhesive 14 may only be required on one of the two mating surfaces (nodes 16, 18), but can also be applied to both. It will be appreciated by those of ordinary skill in the art that the corrugation and application of the adhesive can be done in a number of different ways. Accordingly, the process described herein and shown in FIG. 4 is not a limitation on the present invention. Next, as shown in FIG. 4B, individual corrugated sheets 12 are cut from the role of substrate. In another embodiment, the adhesive 14 can be applied to nodes after the corrugated sheets 12 have been cut from the corrugated substrate 25.

Next, as shown in FIG. 4C, the individual corrugated sheets 12 can be stacked and nested upon each other such that the troughs 13 of an upper corrugated sheet 12 are received in the troughs 13 of a lower corrugated sheet, to form a nested stack 24 for transportation and storage. Because of the nesting, the nested stack 24 takes up less space than the final honeycomb core assembly. Therefore, compared to the prior art in which a honeycomb core is transported and stored, space is saved. However, this is not a limitation on the present invention and the remaining steps described herein to form the honeycomb core assembly 10 can be performed in the same place (the first location) as the corrugation and adhesive application steps.

As shown in FIG. 4D, next, the corrugated sheets 12 are stacked into a honeycomb geometry, as described above, such that the lower node regions 18 of an upper corrugated sheet 12 are positioned adjacent to or in contact with the upper node regions 16 of a lower corrugated sheet 12 (to form a honeycomb stack 26). In the honeycomb stack 26, adjacent troughs 13 and ridges 15 cooperate to form a cell 17. It should be understood that the corrugated sheets 12 do not have to be stacked horizontally. In another embodiment, the honeycomb stack can be formed such that the corrugated sheet 12 are stacked vertically or diagonally. As shown in FIG. 4E, the honeycomb stack 26 is then exposed to a corresponding radio frequency 28, which activates the adhesives 14 and bonds adjacent corrugated sheets 12 to one another. Consequently, the stacked, RF adhesive modified corrugated sheets are bonded at the node regions into a honeycomb core assembly 10 (as shown in FIG. 1). This part of the process can be done at a second location, such as the point of assembly or distribution. It will be appreciated that the second location is remote from the first location. In other words, the first and second locations are at different facilities that require transport by a truck, train, aircraft or the like, as opposed to the first and second locations simply being a different location within the same facility. The radio frequency can be applied in a number of different ways. For example, the radio frequency can be applied to the entire honeycomb stack 26 simultaneously (by a single source), the radio frequency can be applied to individual nodes simultaneously by separate sources, a single source can apply radio frequency to individual nodes at successive times, etc. In other words, RF energy 28 can be applied to the entire block/honeycomb stack 26 bonding all of the nodes at the same time. In another embodiment, RF energy 28 can be directed at individual nodes (for example, if the block/honeycomb stack 26 is to be built and bonded one sheet 12 at a time).

It will be appreciated by those of ordinary skill in the art that the method described herein can be utilized to construct a honeycomb core of any desired size. As shown in FIG. 4F, a honeycomb core member 30 can then be sliced from the honeycomb core assembly 10 to be used as desired.

Any type of RF activatable adhesive 14 is within the scope of the present invention. The adhesive can be comprised solely of an RF activator. In this embodiment, The RF energy is focused at the nodes to facilitate the sheets to soften and adhere to themselves. In another embodiment, the adhesive can contain other resins that could be a finely ground version of the same resin as the substrate or a resin with a lower melting point than the substrate. A vehicle to facilitate application and adhesion to the nodes before bonding can also be used. The RF agent can be a variety of compounds and long as it absorbs the RF energy and produces heat to facilitate the bonding. In one scenario, a RF agent is chosen that has a curie temperature equal to or just above the desired bonding temperature to limit the ultimate temperature at during the bonding (welding). It will be appreciated that the selection of the RF agent and adhesive is dependent on the substrate (corrugated sheets) as well as the radio frequency used.

The RF activatable adhesive can be a blend of RF activators and thermoplastic additives with a percentage weight ratio of a range from above 0% to about 99% to form a thermoplastic adhesive. For other exemplary RF activatable adhesives that can be used see U.S. Publication No. 2014/0163149, published on Jun. 12, 2014 to Leisner, the entirety of which is incorporated herein in its entirety. It will be appreciated that the RF activator can be any chemical that could absorb RF energy to generate adhesives. Generally, the RF activators can be a ferromagnetic compound. In a preferred embodiment, the RF activator has a Curie temperature that is in the near range of the desired node bonding temperature. It will also be appreciated that the thermoplastic material or substrate the RF adhesives applied thereto can be any thermoplastic materials. For example, the thermoplastic material can be nylon, aramid, polyetherimide, acrylonitrile butadiene styrene, polybenzimidazole, polyether ether ketone, polyamideimide, polyethersulfone, polysulfone, polycarbonate. It will be further appreciated that the thermoplastic additives can be a thermoplastic resin of the same thermoplastic material or substrate the RF adhesives applied thereto, or a different thermoplastic material with a different glass transition temperature. It will also be appreciated that RF adhesives can be applied in various thickness, for example, a thickness ranging from about 5 microns to about 200 microns or greater.

It will be appreciated that those of ordinary skill in the art that the RF adhesives can be applied to the corrugated sheet both during the process of corrugation and after the corrugation. In a preferred embodiment, the RF activatable adhesive can be applied to a lower corrugating roller; a sheet of substrate can pass through the lower corrugating roller and be corrugated into a corrugated sheet of substrate while the RF activatable adhesive is transferred onto the corrugated sheet of substrate at the node regions.

It will be appreciated that those of ordinary skill in the art that the RF welding of corrugates sheets to form a honeycomb core can be applied to the other technologies for manufacturing a honeycomb core. For example, the RF adhesives can be applied, in the expansion method, to node regions of flat sheets of substrate, bonded, cured and then expanded to a honeycomb core of a desired size. Similarly, the RF welding can also be applied to the method of bonding unitary thermoplastic half cells into honeycomb core.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed, at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. Accordingly, the applicant reserves the right to add additional claims after filing the application to pursue such additional claim forms for other aspects of the disclosure.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A method of providing a honeycomb core member, the method comprising the steps of:
(a) obtaining a sheet of substrate,
(b) corrugating the sheet of substrate to form a corrugated substrate that includes a plurality of ridges and troughs, wherein each ridge includes an upper node region on an upper surface thereof, and wherein each trough includes a lower node region on a lower surface thereof,
(d) applying radio frequency activatable adhesive to at least some of the upper and lower node regions of the corrugated substrate,
(c) cutting the corrugated substrate into at least first and second corrugated sheets,
(d) positioning the first corrugated sheet adjacent to or in contact with the second corrugated sheet such that at least some of the lower node regions of the first corrugated sheet are in contact with at least some of the upper node regions of the second corrugated sheet to form a honeycomb stack,
(e) exposing the radio frequency activatable adhesive to a radio frequency, whereby the first corrugated sheet is bonded to the second corrugated sheet to form a honeycomb core assembly, and
(f) cutting the honeycomb core member from the honeycomb core assembly.

2. The method of claim 1 further comprising the step of stacking the first corrugated sheet on the second corrugated sheet such that the troughs of the first corrugated sheet are received in the troughs of the second corrugated sheet to form a nested stack, wherein this step is performed prior to step (d).

3. The method of claim 2 further comprising the step of transporting the nested stack from a first location to a second location.

4. The method of claim 3 wherein the second location is remote from the first location.

5. The method of claim 4 wherein the second location is a distribution site or a point of use.

6. A honeycomb core member produced by a process comprising the steps of:
(a) obtaining a sheet of substrate,
(b) corrugating the sheet of substrate to form a corrugated substrate that includes a plurality of ridges and troughs, wherein each ridge includes an upper node region on an upper surface thereof, and wherein each trough includes a lower node region on a lower surface thereof,
(d) applying RF activatable adhesive to at least some of the upper and lower node regions of the corrugated substrate,
(c) cutting the corrugated substrate into at least first and second corrugated sheets,
(d) positioning the first corrugated sheet adjacent to or in contact with the second corrugated sheet such that at least some of the lower node regions of the first corrugated sheet are in contact with at least some of the upper node regions of the second corrugated sheet to form a honeycomb stack,
(e) exposing the radio frequency activatable adhesive to a radio frequency, whereby the first corrugated sheet is bonded to the second corrugated sheet to form a honeycomb core assembly, and
(f) cutting the honeycomb core member from the honeycomb core assembly.

7. The invention of claim 6 wherein the process includes the step of stacking the first corrugated sheet on the second corrugated sheet such that the troughs of the first corrugated sheet are received in the troughs of the second corrugated sheet to form a nested stack, wherein this step is performed prior to step (d).

8. The invention of claim 7 wherein the process includes the step of transporting the nested stack from a first location to a second location.

9. The invention of claim 8 wherein the second location is remote from the first location.

10. The invention of claim 9 wherein the second location is a distribution site or a point of use.

11. A method of bonding a first corrugated sheet and a second corrugated sheet, wherein the first corrugated sheet includes a plurality of lower node regions and the second corrugated sheet includes a plurality of upper node regions, the method comprising the steps of:
(a) applying a radio frequency activatable adhesive to one or both of a first lower node region of the first corrugated sheet and a first upper node region of the second corrugated sheet,
(b) positioning the first corrugated sheet adjacent to or in contact with the second corrugated sheet at the first upper node region and the first lower node region, and
(c) exposing the radio frequency activatable adhesives to a radio frequency to activate the radio frequency activatable adhesive, whereby the first corrugated sheet is bonded to the second corrugated sheet.

12. The method of claim 11 further comprising:
applying a radio frequency activatable adhesive to one or both of a second lower node region of the first corrugated sheet and a second upper node region of the second corrugated sheet prior to step (b).
